(19) United States
(12) Patent Application Publication
(10) Pub. No.: US 2009/0087512 A1
(43) Pub. Date: Apr. 2, 2009

(54) Encapsulated fractions isolated or derived from hops

(76) Inventors: Matthew L. Tripp, Gig Harbor, WA (US); Deanna Minich, Port Orchard, WA (US); Tracey Irving, Gig Harbor, WA (US); Revathy Ramachandran, Sammamish, WA (US); Jeffrey S. Bland, Fox Island, WA (US); Peter Nelson, Port Orchard, WA (US)

Correspondence Address: MCDERMOTT WILL & EMERY LLP, 28 STATE STREET, BOSTON, MA, 02109-1775, US

(21) Appl. No.: 10/846,948

(22) Filed: May 14, 2004

(51) Int. Cl. C12C 3/00; A23L 1/29; A23L 1/221

(52) U.S. Cl. 426/2; 426/89; 426/600; 426/590

(57) ABSTRACT

The invention provides an encapsulation composition comprising a fraction isolated or derived from hops encapsulated in a matrix selected from at least one of the group consisting of a phytosterol and a cyclodextrin.

### BACKGROUND OF THE INVENTION

This invention primarily relates to the composition, method and use of encapsulated fractions derived from hops, and particularly reduced isoalpha acids (RIAA), isoalpha acids (IAA), tetrahydroisoalpha acids (THIAA), hexahydroisoalpha acids (HHIAA), alpha acids, beta acids, spent hops, and hop essential oils. Secondarily, it covers the incorporation of omega-3 fatty acids into the encapsulate.

US patent application publication no. 2003/0113393 discloses that extracts derived from hops (Humulus lupulus) are useful for treating inflammatory diseases. Inflammatory diseases affect more than fifty-million Americans. As a result of basic research in molecular and cellular immunology over the last ten to fifteen years, approaches to diagnosing, treating and preventing these immunologically-based diseases has been dramatically altered. One example of this is the discovery of an inducible form of the cyclooxygenase enzyme. Constitutive cyclooxygenase (COX), first purified in 1976 and clones in 1988, functions in the synthesis of prostaglandins (PGs) from arachidonic acid (AA). Three years after its purification, an inducible enzyme with COX activity was identified and given the name COX-2 while constitutive COX was termed COX-1.

COX-2 gene expression is under the control of pro-inflammatory cytokines and growth factors. Thus, the inference is that COX-2 functions in both inflammation and control of cell growth. While COX-2 is inducible in many tissues, it is present constitutively in the brain and spinal cord, where it may function in nerve transmission for pain and fever. The two isoforms of COX are nearly identical in structure but have important differences in substrate and inhibitor selectivity and in their intracellular locations. Protective PGs, which preserve the integrity of the stomach lining and maintain normal renal function in a compromised kidney, are synthesized by COX-1. On the other hand, PGs synthesized by COX-2 in immune cells are central to the inflammatory process.

The discovery of COX-2 has made possible the design of drugs that reduce inflammation without removing the protective PGs in the stomach and kidney may be COX-1. Combinations of the invention would be useful for, but not limited to, the treatment of inflammation in a subject, and for treatment of other inflammation-associated disorders, such as, as an analgesic in the treatment of pain and headaches, or as an antipyretic for the treatment of fever. For example, combinations of the invention would be useful to treat arthritis, including, but not limited to, rheumatoid arthritis, spondyloathopathies, gouty arthritis, osteoarthritis, systemic lupus erythematosus, and juvenile arthritis. Such combination of the invention would be useful in the treatment of asthma, bronchitis, menstrual cramps, tendonitis, bursitis, and skin related conditions such as psoriasis, eczema, burns and dermatitis. Combinations of the invention also would be useful to treat gastrointestinal conditions such as inflammatory bowel disease, Crohn's disease, gastritis, irritable bowel syndrome and ulcerative colitis and for the prevention or treatment of cancer such as colorectal cancer. Compositions of the inventions would be useful treating inflammation in such diseases as vascular diseases, migraine headaches, periarteritis nodosa, thyroiditis, aplastic anemia, Hodgkin's disease, sclerodma, rheumatic fever, type I diabetes, myasthenia gravis, multiple sclerosis, sarcoidosis, nephrotic syndrome, Behehet's syndrome, polymyositis, gingivitis, hypersensitivity, swelling occurring after injury, myocardial ischemia and the like.

The compositions of the present invention would also be useful in the treatment of ophthalmic diseases, such as retinopathies, conjunctivitis, uveitis, ocular photophobia, and of acute injury to the eye tissue. The compounds would also be useful in the treatment of pulmonary inflammation, such as that associated with viral infections and cystic fibrosis. The compounds would also be useful for the treatment of certain nervous system disorders such as dementias including Alzheimer's disease. The combinations of the invention are useful as anti-inflammatory agents, such as for the treatment of arthritis, with the additional benefit of having significantly less harmful side effects. As inhibitors of COX-2 mediated biosynthesis of PGE2, these compositions would also be useful in the treatment of allergic rhinitis, respiratory distress syndrome, endotoxin shock syndrome, atherosclerosis, and central nervous system damage resulting from stroke, ischemia and trauma.

Besides being useful for human treatment, these compounds are also useful for treatment of other animals, including horses, dogs, cats, birds, sheep, pigs, etc. An ideal formulation for the treatment of inflammation would inhibit the induction and activity of COX-2 without affecting the activity of COX-1. Historically, the non-steroidal and steroidal anti-inflammatory drugs used for treatment of inflammation lack the specificity of inhibiting COX-2 without affecting COX-1. Therefore, most anti-inflammatory drugs damage the gastrointestinal system when used for extended periods. Thus, new COX-2 specific treatments for inflammation and inflammation-based diseases are urgently needed.

The identification of humulone from hops extract as an inhibitor of bone resorption is reported in Tobe, H. et al. 1997. Bone resorption Inhibitors from hop extract. Biosci. Biotech. Biochem 61(1)158-159. Later studies by the same group characterized the mechanism of action of humulone as exhibition of COX-2 gene transcription following TNFalpha stimulation of MC3T3, E1 cells [Yamamoto, K. 2000. Suppression of cyclooxygenase-2 gene transcription by humulon of bee hop extract studied with reference to glucocorticoid. FEBS Letters 465:103-106].

Thus, it would be useful to identify a natural formulation of compounds that would specifically inhibit or prevent the synthesis of prostaglandins by COX-2 with little or no effect on COX-1. Such a formulation, which would be useful for preserving the health of joint tissues, for treating arthritis or other inflammatory conditions, has not previously been discovered. The term “specific or selective COX-2 inhibitor” embrace compounds or mixtures of compounds that selectively inhibit COX-2 over COX-1. Preferably, the compounds have a median effective concentration for COX-2 inhibition that is minimally five times greater than the effective concentration for the inhibition of COX-1. For example, if the median inhibitory concentration for COX-2 of a test formulation was 0.2 .mu.g/mL, the formulation would not be considered COX-2 specific unless the median inhibitory concentration for COX-1 was equal to or greater than 1 .mu.g/mL.

It would be advantageous to provide compositions of fractions isolated or derived from hops in formulations comprising an effective amount of hops derivatives for release of the active ingredient at a desired site in the gastro-intestinal tract, for instance in the stomach or the intestines. The inventors of the present invention have discovered that certain encapsulation compositions comprising fractions isolated or derived from hops achieve this advantageous result.

In general, it is known in the field of encapsulation that current practical commercial processes leading to stable, dry flavors are generally limited to spray drying and extrusion fixation.

U.S. Pat. No. 3,971,852, to Brenner et al., teaches the use of modified starch, gums and other natural hydro-colloids with lower molecular weight polyhydroxy compounds to yield a glassy cellular matrix with encapsulated oil at a maximum of 80 volume %. This system forms a shell surrounding the oil flavoring but is limited to lipophilic flavoring agents. Saleeb and Pickup, in U.S. Pat. No. 4,532,145, describe a process and composition in which a volatile flavorant is fixed by spray drying from a carrier solution made up of 10-30% of a low molecular weight component such as a sugar or an edible food acid with the balance of solids being a maltodextrin carbohydrate in the amount of 70-90%. U.S. Pat. No. 5,124,162, to Boskovic et al., discloses a carrier mixture composed of mono- and disaccharides (22-45%), maltodextrins (25-50%), and a high molecular weight carbohydrate such as gum arabic, gum acacia or chemically modified starch (10-35%) to which flavoring agents are added and the subsequent solution spray dried to yield a free flowing powder with a bulk density of 0.50 g/cc.

An alternative route to encapsulating flavorings is taught by Sair and Sair, in U.S. Pat. No. 4,230,687. In this approach, high molecular weight carriers such as proteins, starches or gums are plasticized by addition of water in the presence of the encapsulate and subjected to a high shear dispersive process. The dispersed matrix plus encapsulate is then recovered and dried to yield a stable product.

Another alternative process, melt extrusion, can be utilized for flavor fixation and encapsulation. In this process, a melting system, i.e. an extruder, is employed to form the carrier melt in a continuous process. The encapsulate flavor is either admixed or injected into the molten carbohydrate carrier. Saleeb and Pickup teach, in U.S. Pat. No. 4,420,534, use of a matrix composition consisting of 10 to 30 wt % of a low molecular weight component chosen from a series of mono- or disaccharides, corn syrup solids, or organic acid with the balance of the mixture being maltodextrin. The matrix base is dry blended with an anhydrous liquid flavoring component and melted in a single screw extruder to yield a solid matrix characterized as a glass with a glass transition temperature >40° C.

Levine and Slade, in U.S. Pat. Nos. 5,087,461 and 5,009,900, teach a similar approach utilizing a composition consisting of a modified food starch, maltodextrin, polyol, and mono- and disaccharide components. The starch is a chemically modified, water-soluble starch and is used in an amount of 40 to 80% of the total mixture. The balance of the composition is comprised of 10-40% of maltodextrin, 5 to 20% of corn syrup solids or polydextrose and 5-20% of mono- or disaccharide. This matrix is made to balance processing response with glass matrix character.

Various other encapsulation compositions are known. For example, see U.S. Pat. Nos. 5,603,971; 5,897,897; 6,277,428; 6,416,799; 6,541,045; 6,652,895; and 6,689,388; and US patent publications 2002/0086062; 2002/0189493; and 2003/0026874.

### SUMMARY OF THE INVENTION

The invention provides an encapsulation composition comprising a fraction isolated or derived from hops encapsulated in a compatible matrix but excluding a matrix comprising maltodextrins, modified starches, gum arabic, gelatin, hydrolyzed gelatin, and/or larch gum. Most preferably the invention provides an encapsulation composition comprising a fraction isolated or derived from hops encapsulated in a matrix selected from at least one of the group consisting of a phytosterol and a cyclodextrin. The invention also provides food products or beverages containing encapsulation compositions of the above kind. The invention further provides methods of using encapsulation compositions of the above kind. Still further, the invention provides methods of making encapsulation compositions of the above kind.

### DETAILED DESCRIPTION OF THE INVENTION

The present invention provides compositions, methods, and uses of encapsulated fractions derived from hops. The encapsulating material may be phytosterols and cyclodextrins. Phytosterols are sterol compounds produced by plants which are structurally very similar to cholesterol except that they always contain some substitutions at the C₂₄ position on the sterol side chain. Common plant sterols include the unsaturated sterols beta-sitosterol, campesterol, and stigmasterol, and their saturated counterparts sitostanol and campestanol. Dietary sources of phytosterols are corn oil, soybean oil, and other plant oils which contain the relatively hydrophobic compounds. Cyclodextrins (CD's) are annular glucose polymers, which are called alpha, beta or gamma cyclodextrin depending on the number of glucose moieties present, namely for 6, 7 or 8, respectively. A lipophilic cavity exists in the center of a cyclodextrin, where lipophilic substances can be enclosed. This property of cyclodextrins can be used to render hydrophobic substances water soluble. Preferably cyclodextrin oligomers are able to encapsulate hydrophobic substances. The bridging structures or spacers between the cyclodextrins determine the distance between the cavities and thereby the size of the molecule that can be encapsulated. The spacer structures have to be rigid to ensure the correct orientation of the cyclodextrin moieties for the retention of the cavity structure. Therefore the spacer structures contain preferably chemical bonds that cannot rotate freely.

The protected molecule is released upon cleavage of either the cyclodextrins or the bridging structures between the cyclodextrins. The necessary destruction of the complex and the consequent liberation of the included pharmaceutically active substance at the target site can be effected easily by hydrolysis of the cyclodextrin by a specific enzyme (Moser Ser. '223) or preferably by destruction of the spacer B′. In both cases the affinity between pharmaceutically active substance and covering CD's ceases by 4 orders of magnitude, and the pharmaceutically active substance slips out of the complex into the next living cell. The synthesis of CD-dimers is well known (See, for example A. Rubner et al. J. Inclin. Phenom. 27 69-84 (1997)). See, for example, U.S. Pat. No. 6,602,988.

As used herein, the term “dietary supplement” refers to compositions consumed to affect structural or functional changes in physiology. The term “therapeutic composition” refers to compounds administered to treat or prevent a disease or to ameliorate a sign or symptom associated with a disease.

As used herein, the term “effective amount” means an amount necessary to achieve a selected result. Such an amount can be readily determined without undue experimentation by a person of ordinary skill in the art.

As used herein, the term “substantial” means being largely but not wholly that which is specified.

As used herein, the terms “derivatives” or a matter “derived” refer to a chemical substance related structurally to another substance and theoretically obtainable from it, that is, a substance that can be made from another substance. Derivatives can include compounds obtained via a chemical reaction. Methods of making derivatives of compounds are well known to those skilled in the art.

As used herein, the term “hop extract” refers to the solid material resulting from (1) exposing a hops plant product to a solvent, (2) separating the solvent from the hops plant products, and (3) eliminating the solvent.

As used herein, the term “solvent” refers to a liquid of aqueous or organic nature possessing the necessary characteristics to extract solid material from the hop plant product. Examples of solvents would include, but are not limited to, water, steam, superheated water, methanol, ethanol, hexane, chloroform, methylene chloride, liquid supercritical CO₂, liquid N₂, or combinations of such materials.

As used herein, the term “CO₂ extract” refers to the solid material resulting from exposing a hops plant product to a liquid or supercritical CO₂ preparation followed by the removing of the CO₂.

As used herein, the term “spent hops” refers to the solid and hydrophilic residue from the extraction of hops.

As used herein, the term “alpha acid” refers to compounds collectively known as humulones and can be isolated from hops plant products including, among others, humulone, cohumulone, adhumulone, hulupone, and isoprehumulone.

As used herein, the term “isoalpha acid” refers to compounds isolated from hops plant products and which subsequently have been isomerized. The isomerization of alpha acids can occur thermally, such as boiling. Examples of isoalpha acids include, but are not limited to, isohumulone, isocohumulone, and isoadhumulone.

As used herein, the term “reduced isoalpha acid” (also sometimes referred to as dihydroisoalpha acids or rho-isoalpha acids) refers to alpha acids isolated from hops plant product and which subsequently have been isomerized and reduced, including cis and trans forms. Examples of reduced isoalpha acids (RIAA) include, but are not limited to, dihydro-isohumulone, dihydro-isocohumulone, and dihydro-adhumulone.

As used herein, the term “tetra-hydroisoalpha acid” refers to a certain class of reduced isoalpha acid. Examples of tetra-hydroisoalpha acid (THIAA) include, but are not limited to, tetra-hydro-isohumulone, tetra-hydro-isocohumulone and tetra-hydro-adhumulone.

As used herein, the term “hexa-hydroisoalpha acid” refers to a certain class of reduced isoalpha acid. Examples of hexa-hydroisoalpha acids (HHIAA) include, but are not limited to, hexa-hydro-isohumulone, hexa-hydro-isocohumulone and hexa-hydro-adhumulone.

As used herein, the term “beta-acid fraction” refers to compounds collectively known as lupulones including, among others, lupulone, colupulone, adlupulone, tetrahydroisohumulone, and hexahydrocolupulone.

As used herein, the term “essential oil fraction” refers to a complex mixture of components including, among others, myrcene, humulene, beta-caryophyleen, undecane-2-on, and 2-methyl-but-3-en-ol.

As used herein, the term “compatible matrix” refers to a material which when combined with the fraction isolated or derived from hops retains a solid mass structure at room temperature and is not deleterious to the activity of the hop fraction(s). Such matrix materials can be readily determined without undue experimentation by a person of ordinary skill in the art.

At its simplest, hop extraction involves milling, pelleting and re-milling the hops to spread the lupulin, passing a solvent through a packed column to collect the resin components and finally, removal of the solvent to yield a whole or “pure” resin extract.

The composition of the various extracts is compared in Table 1.

TABLE 1
Hop extracts (Percent w/w)

| | | | Super-Critical | |
|---|---|---|---|---|
| Component | Hops | Organic Solvent | CO₂ | Liquid CO₂ |
| Total resins | 12-20 | 15-60 | 75-90 | 70-95 |
| Alpha-acids | 2-12 | 8-45 | 27-55 | 30-60 |
| Beta-acids | 2-10 | 8-20 | 23-33 | 15-45 |
| Essential oils | 0.5-1.5 | 0-5 | 1-5 | 2-10 |
| Hard resins | 2-4 | 2-10 | 5-11 | None |
| Tannins | 4-10 | 0.5-5 | 0.1-5 | None |
| Waxes | 1-5 | 1-20 | 4-13 | 0-10 |
| Water | 8-12 | 1-15 | 1-7 | 1-5 |

The main organic extractants are strong solvents and in addition to virtually all the lupulin components, they extract plant pigments, cuticular waxes, water and water-soluble materials.

Supercritical CO₂ is more selective than the organic solvents and extracts less of the tannins and waxes and less water and hence water-soluble components. It does extract some of the plant pigments like chlorophyll but rather less than the organic solvents do. Liquid CO₂ is the most selective solvent used commercially for hops and hence produces the most pure whole resin and oil extract. It extracts hardly the hard resins or tannins, much lower levels of plant waxes, no plant pigments and less water and water-soluble materials.

As a consequence of this selectivity and the milder solvent properties, the absolute yield of liquid CO₂, extract per unit weight of hops is less than when using the other mentioned solvents. Additionally, the yield of alpha acids with liquid CO₂ (89-93%) is lower than that of supercritical CO₂ (91-94%) or the organic solvents (93-96%). Following extraction, there is the process of solvent removal, which for organic solvents involves heating to cause volatilization. Despite this, trace amounts of solvent do remain in the extract. The removal of CO₂, however, simply involves a release of pressure to volatize the CO₂.

Hop CO₂ extracts can be fractionated into components, including hops oils, beta acids, and alpha acids. Hops oils include, but are not limited to, humulene, beta-caryophyllene, mycrene, farnescene, gamma-cadinene, alpha-selinene, and alpha-cadinene. Beta acids include, but are not limited to, lupulone, colupulone, adlupulone, tetrahydroisohumulone, and hexahydrocolupulone, collectively known as lupulones. Beta acids can be isomerized and reduced. Beta acids are reduced to give tetra-beta acids. Alpha acids include, but are not limited to, humulone, cohumulone, adhumulone, hulupone, and isoprehumulone. Alpha acids can be isomerized to give isoalpha acids. Iso-alpha acids can be reduced to give reduced-isoalpha acids, tetra-hydroisoalpha acids, and hexa-hydroisoalpha acids.

Tetrahydroiso-alpha-acids (tetrahydroisohumulones) usually are prepared from the beta-acids (or lupulones) in hop extracts. The hop extracts also contain alpha-acids (or humulones) but they are not normally used to make tetrahydroiso-alpha-acids for economical reasons. Alpha-acids and beta-acids are often referred to as “soft resins”. The alpha-acids consist of three major analogs: cohumulone, humulone and adhumulone. Beta-acids consist of three major analogs: colupulone, lupulone and adlupulone. Tetrahydroiso-alpha-acids can be prepared from either alpha-acids or from beta-acids which results in three analogs and two diastereoisomers. They are cis and trans-isomers of tetrahydroiso-cohumulone (THICO), tetrahydroiso-humulone (THISO) and tetrahydroiso-adhumulone (THIAD).

Worden, et al., U.S. Pat. No. 3,552,975, teach a method employing organic solvents and lead salts to make tetrahydroiso-alpha-acids from beta-acids. The final product is a crude mixture from which the lead residues can only be removed with great difficulty. The presence of residual lead in products to be consumed is obviously undesirable.

Worden, U.S. Pat. No. 3,923,897, discloses a process for preparing tetrahydroiso-alpha-acids from beta-acids by oxidizing desoxytetrahydro-alpha-acids (resulting from the hydrogenation of beta-acids) with a peracid followed by the isomerization of the resulting tetrahydro-alpha-acids. The process does not utilize lead salts but it is conducted in water immiscible organic solvents and it involves cumbersome solvent changes which increase process cost. The presence of even residual amounts of such solvents in food products, such as beverages, is undesirable.

Cowles, et al., U.S. Pat. No. 4,644,084, disclose a process for making tetrahydroiso-alpha-acids by treating beta-acids to form desoxytetrahydro-alpha-acids which are dissolved in an aqueous alcoholic caustic solution and then oxidized with an oxygen-containing gas to form the desired tetrahydrois-alpha-acids. The Cowles, et al. process does not use undesirable organic solvents and is superior to other known processes using beta-acids.

Hay, U.S. Pat. No. 5,013,571, teaches a process for simultaneously isomerizing and reducing alpha acids to tetrahydroiso-alpha-acids (THIAA). The Hay process uses relatively high pHs (8 to 10), significant amounts of water, high temperature, and hydrogen pressures above about 50 psig. As a result, side reactions can take place that can result in undesired products. Furthermore, the desired tetrahydroiso-alpha-acids are not easily isolated from the Hay reaction mixture.

Hydrogenation and hydrogenolysis are well-known processes which are commonly employed in many organic chemical synthesis schemes, including the manipulation of lupulones and humulones, and their derivatives. Usually, low molecular weight organic compounds are used as solvents (C.sub.1-C.sub.6). For example, Carson, 73 J. Am. Chem. Soc. 1850-1851 (1951), discusses the hydrogenation of lupulone and humulone using methanol as a solvent. Anteunis, et al., Bull. Soc. Chim. Belg. 476-483 (1959), disclose carrying out the hydrogenation of humulone in methanol or ethanol.

Wilkinson, U.S. Pat. No. 3,933,919, discloses hydrogenation, hydroformylation and carbonylation reactions using methanol, ethanol, and benzene as solvents. The Cowles patent, supra, discloses a process for hydrogenating beta acids to form desoxytetrahydro-alpha-acids where ethanol is used as a solvent. Todd, Jr., et al., U.S. Pat. Nos. 5,082,975 and 5,166,449, disclose the hydrogenation in water/methanol of beta acids to form hexahydro-beta-acids. Stegink, et al., U.S. Pat. No. 5,296,637, teach hydrogenation of alpha acids to form tetrahydro-alpha-acids using an aqueous or aqueous/lower alkanol solvent medium.

For a detailed discussion of the above methods of making various fractions isolated or derived from hops, see U.S. Pat. No. 6,020,019.

In one commercial process, alpha acids are isomerized and reduced to dihydroisoalpha acids under basic conditions with a reducing agent such as sodium borohydride at elevated temperatures. In another commercial process, alpha acids are isomerized into isoalpha acids under basic conditions at elevated temperatures. Tetrahydroisoalpha acids are produced commercially by a multi-step route from beta acids, and hexahydroisoalpha acids are produced commercially by a reduction of tetrahydroisoalpha acids.

In addition, the literature teaches the hydrogenation of normal homolog isoalpha acids at a pH of about 3 resulting in low yields of tetrahydroisoalpha acid (P. M. Brown, G. A. Howard and A. B. Tatchell, J. Chem. Soc. 545 (1959)). That reference also teaches the hydrogenation with platinum oxide of normal homolog isoalpha acids at a pH of about 10 to give a low yield of isoalpha acids with only one double bond hydrogenated. The reference also teaches the hydrogenation of normal homolog isoalpha acids at a pH of about 3 to yield a deoxygenated THIAA. Another reference teaches the reduction of THIAA to deoxygenated products by hydrogenation with palladium on carbon in methanol at a pH of about 3 (E. Byrne and S. J. Shaw, J. Chem. Soc. (C), 2810 (1971)).

For detailed discussions of methods for making various fractions isolated or derived from hops, see U.S. Pat. Nos. 5,013,571 and 6,583,322.

The invention provides compositions containing at least one fraction isolated or derived from hops (Humulus lupulus). Examples of fractions isolated or derived from hops are alpha acids, isoalpha acids, reduced isoalpha acids, tetra-hydroisoalpha acids, hexa-hydroisoalpha acids, beta acids, and spent hops. Fractions isolated or derived from hops, include, but are not limited to, cohumulone, adhumulone, isohumulone, isocohumulone, isoadhumulone, dihydro-isohumulone, dihydro-isocohumulone, dihydro-adhumulone, tetrahydro-isohumulone, tetrahydro-isocohumulone, tetrahydro-adhumulone, hexahydro-isohumulone, hexahydro-isocohumulone, and hexahydro-adhumulone. Preferred compounds can also bear substituents, such as halogens, ethers, and esters.

Compounds of the fractions isolated or derived from hops can be represented by a supragenus below:

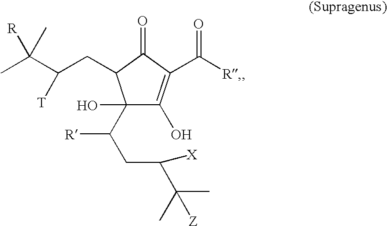

wherein R′ is selected from the group consisting of carbonyl, hydroxyl, OR, and OCOR, wherein R is alkyl; wherein R″ is selected from the group consisting of CH(CH₃)₂, CH₂CH(CH₃)₂, and CH(CH₃)CH₂CH₃; and wherein R, T, X, and Z are independently selected from the group consisting of H, F, Cl, Br, I, and π orbital, with the proviso that if one of R, T, X, or Z is a π orbital, then the adjacent R, T, X, or Z is also a π orbital, thereby forming a double bond.

In another embodiment, compounds of the fractions isolated or derived from hops can be represented by a genus below:

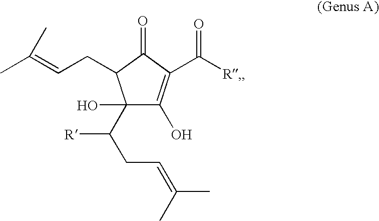

wherein R′ is selected from the group consisting of carbonyl, hydroxyl, OR, and OCOR, wherein R is alkyl; and wherein R″ is selected from the group consisting of CH(CH₃)₂, CH₂CH(CH₃)₂, and CH(CH₃)CH₂CH₃. Exemplary Genus A structures include isoalpha acids such as isohumulone, isocohumulone, isoadhumulone, and the like, and reduced isoalpha acids such as dihydro-isohumulone, dihydro-isocohumulone, dihydroadhumulone, and ether or ester conjugates or halogenated modifications of the double bond.

In yet another embodiment, compounds of the fractions isolated or derived from hops can be represented by a genus below:

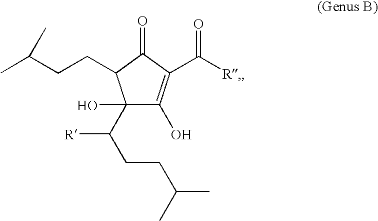

wherein R′ is selected from the group consisting of carbonyl, hydroxyl, OR, and OCOR, wherein R is alkyl; and wherein R″ is selected from the group consisting of CH(CH₃)₂, CH₂CH(CH₃)₂, and CH(CH₃)CH₂CH₃. Exemplary Genus B structures include tetra-hydroisoalpha acids such as tetra-hydro-isohumulone, tetra-hydro-isocohymulone and tetra-hydro-adhumulone, and the like, and hexa-hydroisoalpha acids such as hexa-hydro-isohumulone, hexa-hydro-isocohumulone and hexa-hydro-adhumulone, and ether or ester conjugates.

Examples of compounds of an ingredient isolated or derived from hops, include, but are not limited to, humulone, cohumulone, adhumulone, isohumulone, isocohumulone, isoadhumulone, dihydro-isohumulone, dihydro-isocohumulone, dihydro-adhumulone, tetrahydro-isohumulone, tetrahydro-isocohumulone, tetrahydro-adhumulone, hexahydro-isohumulone, hexahydro-isocohumulone, and hexahydro-adhumulone. The preferred compounds can bear substituents, as shown in the formula above.

Hops derivatives are known compounds occurring naturally in plants and found in food products and beverages. They may be prepared by any of the extraction and processing methods known in the art. Hops derivatives can be prepared directly from plant material in any known manner. The hops derivatives may be purified by methods known in the art, for example, by recrystallization from aqueous organic solvents such as aqueous alcohols. Synthetic modifications of hops derivatives may be prepared according to methods known in the pharmaceutical art of drug modification.

The composition of the encapsulated material would be a specific fraction from hops, including but not limited to the following: RIAA, IAA, THIAA, HHIAA, alpha acids, beta acids and hop essential oils, plus encapsulates: e.g., phytosterols and This combination of hop-derived material and encapsulate may be accompanied by the inclusion of omega-3 fatty acids such as eicosapentanoic and docosahexanoic acids.

Compositions would include encapsulant techniques/materials to provide; a) protection from dissolution in an aqueous solution; b) dissolution in the stomach or in an acidic pH; c) dissolution in the small intestine; d) dissolution in the large intestine; and/or e) a combination of any of the aforementioned.

### A. Method(s) of Use

1. To reduce or eliminate bitter flavor imparted by the hops-derived ingredient for use in a food or beverage, or chewing gum, lozenge, etc. application whereby bitterness is not desired.
2. To enhance stability of hops-derived ingredients and/or omega-3 fatty acids
3. To encapsulate to provide timed or sustained release
4. To encapsulate to provide targeted delivery past the stomach, for release along the course of the intestinal tract, and for example, in some instances into the large intestine (for the purpose of reducing inflammation, and as an antibacterial and/or antiparasitic).

### B. Process

To take either an oleoresin of a particular hops-derived material or 30% hops-derived extract in olive oil and add enough of an encapsulant (e.g., phytosterols and cyclodextrins) to make a hard composite which can be ground cryogenically or otherwise to provide a fine particle size powder which can be used for inclusion into a food, beverage, etc. product. Alternatively, another oil could also be used such as one conveying a synergist antiinflammation activity and include high omega 3 oils (e.g, fish, borage), or other components such as tocopherols (e.g., rice bran oil; barley oil), tocotrienols (e.g., rice bran oil; barley oil), or policosanols (e.g., sugar cane wax).

The following examples are intended to illustrate but not in any way limit the invention.

### Methods

In a preferred embodiment, two encapsulants for the encapsulation of hop fraction(s), are, for example, (1) phytosterols and (2) beta-cyclodextrins.

In a preferred embodiment, the method of making the edible composition comprises the steps of first heating a designated amount of phytosterols until they have liquefied. Once liquefication has occurred, phytosterols are removed from heat source and hop fraction in oil is added in a specified amount, so that the ratio of phytosterol to hop fraction in oil is 1:1. This mixture is homogenized, cooled and cryogenically ground for fine particles. The resulting composition can be subsequently incorporated into a powdered medical food beverage for consumption.

The hop fraction to be used in preparing the edible composition according to the present invention includes as a single ingredient or in combination, but not limited to, the following: RIAA, IAA, THIAA, HHIAA, alpha acids, beta acids and hop essential oils.

The phytosterol blended with the hydrophobic mixture can be any which can be incorporated into an edible aqueous mixture and which imparts a smooth and pleasing mouth-feel. In a preferred embodiment, the phytosterol is selected from the group consisting of sitosterol, campesterol, taraxasterol, stigmasterol, and brassicasterol, or mixtures thereof. Commercially available phytosterols are often mixtures of phytosterols that are also appropriate for use according to the present invention.

In another preferred embodiment, the mixture further comprises an emulsifier. Preferably, the emulsifier utilized in the edible composition is a low HLB emulsifier that has an HLB value from about 0.1 to about 10. Optionally, the low HLB emulsifier is combined with a high HLB emulsifier having a HLB value from about 10 to about 14.

The weight ratio of the emulsifier to the phytosterol can vary from about 0.2:1 to about 5:1. Preferably, the weight ratio of the emulsifier to the phytosterol is from about 0.5:1 to about 2:1.

The mixture comprising a hop fraction, a phytosterol and optionally an emulsifier is then heated to an appropriate temperature. In a preferred embodiment, the mixture is heated to a temperature of about 60.degree. C. to about 145.degree. C. More preferably, the mixture is heated to a temperature of about 80.degree. C. to about 100.degree. C.

The homogenizing step may be accomplished with any conventional homogenizing equipment with either a single stage or a two-stage operation. The mixture is homogenized at a pressure, which allows the integration of the phytosterols with the hop fraction in oil and optionally, the emulsifier. Preferably, the mixture is homogenized at a pressure between 1,000 and 10,000 pounds per square inch. More preferably, the mixture is homogenized at a pressure between 2,000 and 5,000 pounds per square inch.

In a preferred embodiment, the homogenized mixture is ground or prilled to produce a powdered product before they are added to the aqueous solution. Prilling is a well known process, and any prilling process known in the art may be used in the present invention. See, e.g., U.S. Pat. No. 4,238,429. Preferably, the homogenized mixture can be spray prilled. Grinding or prilling the homogenized mixture prior to their addition to the aqueous solution allows for a free-flowing product, which helps incorporate the compounds into the aqueous system.

The edible phytosterol composition may be used as an ingredient in the manufacture of another food product, as an additive in food products, alone as a functional food or included into a medical food. For example, the edible composition may be used as an ingredient in a beverage or any other food product where a liquid ingredient can be used. The composition has a smooth mouth-feel, which does not impart any graininess.

In another embodiment of the invention, the phytosterol composition is dried after homogenization to produce a lipid dispersible powder. The process used for drying the mixture is not critical. Any process known in the art, which would produce a good free-flowing dispersible product may be used. For example, the mixture can be spray-dried, flash-dried, freeze-dried or dried in any other way which produces a powder either directly or through a grinding step.

The dried powder can then be used as an ingredient in a finished food product, which requires powder as an ingredient, as a food additive or alone as a functional food. Further, the powder is storage stable. The co-dried phytosterol-hop fraction powder of the invention allows high melting hydrophobic phytosterols to be incorporated into aqueous products such as, e.g., nutritional beverages or powdered mixes.

In a preferred embodiment, the method of making the edible composition comprises the use of beta-cyclodextrin as an encapsulant. The majority of the components of important essential oils and flavor substances are of a size which can fit tightly into the cavity of the beta-cyclodextrin molecule to form inclusion complexes. This phenomenon constitutes the basis of molecular encapsulation of components of aroma substances by means of the formation of beta-cyclodextrin inclusion complexes. Aroma complexes have been prepared by adding the aroma substance dissolved in ethanol or diethyl ether under vigorous stirring to an aqueous solution of beta-cyclodextrin saturated at 50 degrees C. It is important to add the solution of the flavor substances only dropwise in order to avoid the formation of an emulsion. With aroma substances, which produced immediately an emulsion when added to the aqueous cyclodextrin solution, the complex was prepared in a 30% aqueous ethanol solution. In this solvent mixture, cyclodextrin has maximum solubility. After the termination of the addition, the temperature should be maintained for further 15 minutes; thereafter, the reaction mixture is cooled to room temperature under steady stirring for 4 and a half hours. The mixture is stored for 12 hours at about 0 degrees C., then filtered and dried. In certain cases the solvent is removed by freeze-drying, in which case an amorphous white powder is obtained. The resulting composition can be subsequently incorporated into a powdered medical food beverage for consumption. General Reference: Cyclodextrins in “Comprehensive Supramolecular Chemistry,” Volume 3: Elsevier Science Inc. 660 White Plains Rd. Tarrytown, N.Y. 10591. Procedure used is from: Szejtli, J., Szente, L. and Banky-Elod, E. (1979) and Molecular encapsulation of volatile, easily oxidizable labile flavour substances by clyclodextrins. Acta Chimica Acad. Scien. Hung. 101(1-2): 27-46

It is believed that encapsulation of fractions isolated or derived from hops in cyclodextrins may enhance the bioavailability of the hop fractions. In a different context, it was demonstrated that the bioavailability cogranulated and oven-dried ibuprofen (IBU) and beta-cyclodextrin (betaCD), in comparison to a physical mixture, was almost one and a half times that of the physical mixture. See Ghorab, et al., J. Pharm. Sci. 2003 August; 92(8):1690-7.

Having now generally described the methodology, the same will be more readily understood through reference to the following examples, which are provided by way of illustration, and are not intended to be limiting of the present invention, unless specified.

### EXAMPLE 1

### Hardness Tests to Determine Ideal Ratio of Phytosterols to Olive Oil for Retaining a Solid Mass Structure at Room Temperature

Summary—This example illustrates preliminary tests conducted for the purpose of determining the ratio of phytosterols to olive oil that would be needed for retaining a solid mass structure at room temperature.

Chemicals and Reagents—Phytosterol complex with a particle size of 20 mesh was derived from vegetable oil distillates was from Degussa, Inc. (Champaign, Ill.). The major phytosterol within the complex was beta-sitosterol (>40%), followed by campesterol (>20%), stigmasterol (>11%) and brassicasterol (>0.3%). Olive oil was obtained from Columbus Foods (Chicago, Ill.). Olive oil was chosen as a representative carrier of hop fractions since it contains a small percentage of native phytosterols.

The experiment involved adding a specified number of grams of phytosterols to a 250 mL beaker and warming the phytosterols on a hotplate until they were liquefied (135 degrees C. to 145 degrees C.). Once the phytosterols liquefied, the beaker was removed from the hotplate and a specific amount of olive oil was added so that the total weight of the phytosterols and olive oil combined was 50 grams. Since the objective of this experiment was to determine at which ratio the phytosterols and olive oil would harden, various ratios of phytosterols to olive oil were tested, including the following:

1) 50:50 mixture with 25 grams each of phytosterols and olive oil

2) 60:40 mixture with 30 grams of phytosterols and 20 grams of olive oil

3) 70:30 mixture with 35 grams of phytosterols and 15 grams of olive oil

4) 80:20 mixture with 40 grams of phytosterols and 10 grams of olive oil

The resulting phytosterol and olive oil mixture was stirred with a glass rod for two minutes to ensure homogeneity. The resulting mixture was allowed to cool and harden at room temperature for 10-20 minutes. The hardened material was molded with a round tablet die from Thomas Engineering, Inc. (Hoffman Estates, Ill.) to a particular, defined shape and size (16 mm diameter). The molded material was measured for hardness using a hardness tester (Erweka GmbH, Germany). The test procedure was the following:

Five tablets from each sample were tested individually. The sample was placed in the testing jaw with tweezers or forceps and the test is run. The load was applied along the radial axis of the tablet, as indicated in the diagram below.

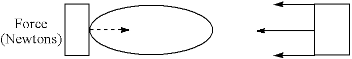

After testing, the broken tablet pieces were removed from the testing jaw using a brush. The average of hardness of 5 tablets is recorded in Newtons. Hardness measurements were recorded in Newtons.

The results below show that significant hardness was obtained for all ratios. As the optimal ratio would be to include more olive oil in the mixture, the 50:50 ratio would be preferred.

| | Phytosterols:Oil | | | | |
|---|---|---|---|---|---|
| | 50:50 | 60:40 | 70:30 | 80:20 | 100% |
| Hardness in Newtons | 77 | 133 | 134 | 164 | 345 |

### EXAMPLE 2

### Preparation of a Phytosterol Composition Containing Magnesium Salt of Rho-Iso-Alpha-Acids (Mg RIAA)

Summary—This example illustrates a preferred embodiment containing phytosterols and the magnesium salt of rho-iso-alpha-acids.

Chemicals and Reagents—Phytosterol complex with a particle size of 20 mesh was derived from vegetable oil distillates was from Degussa, Inc. (Champaign, Ill.). The major phytosterol within the complex is beta-sitosterol (>40%), followed by campesterol (>20%), stigmasterol (>11%) and brassicasterol (>0.3%). The magnesium salt of rho-iso-alpha-acids (Mg RIAA) produced from a CO₂ extract of hops was obtained from John L. Haas, Inc. (Yakima, Wash.).

A phytosterol composition was prepared using the following method. 45 grams of phytosterol complex was added to a 250 mL beaker and placed on a hotplate until they liquefied (135 degrees A phytosterol composition was prepared using the following method. 45 grams of phytosterol C to 145 degrees C.). Once phytosterols liquefied, beaker was removed from the hotplate and 5 grams magnesium salt of Mg RIAA was added for a resulting 10% Mg RIAA in phytosterols mixture. The mixture was stirred with a glass rod for two minutes to ensure homogeneity. The resulting mixture was allowed to cool and harden at room temperature for 10 to 15 minutes before grinding it to a powder using a mortar and pestle.

### EXAMPLE 3

### Preparation of a Beta-Cyclodextrin Composition Containing REDIHOP®

Summary—This example illustrates a preferred embodiment containing beta-cyclodextrin and Redihop®.

Chemicals and Reagents—Beta-cyclodextrin was sourced from Cerestar (Hammond, Ind.) and Redihop® (RIAA), an aqueous, alkaline solution of the potassium salts of rho-iso-alpha-acids produced from a CO₂ extract of hops, was obtained from John I. Haas, Inc. (Yakima, Wash.). Acetic acid was from VWR (Westchester, Pa.).

Beta cyclodextrin (28.8 grams, 0.5 moles) was added to 250 mL water for a suspension. The pH was lowered to ˜5 with acetic acid and heated to ˜60° C. Redihop®, in a 1:1 molar ratio with cyclodextrin, was dissolved in a minimal volume of ethanol (3 mL total) and then added drop wise with a Pasteur pipet to the beta-cyclodextrin suspension with constant stirring using a magnetic stirrer. The total time to add the entire amount of Redihop® was ten minutes.

The suspension was allowed to stand ˜30 minutes at 50 degrees C. with continued stirring using a magnetic stirrer. The suspension was allowed to cool to room temperature, and then it was placed in a refrigerator overnight at 4 degrees C.

The precipitated beta-cyclodextrins were filtered from the suspension using a Whatman no. 1 filter paper, after which the filter paper was washed with cold water to remove any excess material. The filter material was allowed to air dry and the resulting material was a light, powdered granule material.

### EXAMPLE 4

### Preparation of a Beta-Cyclodextrin Composition Containing Magnesium Salt of RIAA®

Summary—This example illustrates another preferred embodiment containing beta-cyclodextrin and Redihop®.

Chemicals and Reagents—Beta-cyclodextrin (Cavitron 82800) was sourced from Cerestar (Cargill, Inc. IA) and Magnesium salt of rho-iso-alpha-acids produced from a CO₂ extract of hops, was obtained from John I. Haas, Inc. (Yakima, Wash.).

Beta cyclodextrin (4.5 grams), was added to 250 mL water for a suspension. The pH of the suspension was 5.0 by addition of acetic acid. The Cyclodextrin in water was heated to ˜60 C. The suspension was maintained at 60 C for 30 minutes with constant stirring using a magnetic stirrer. 02.0 grams of the Magnesium salt of RIAA was dissolved in a 10 ml of ethanol maintained at ˜60 C. The Magnesium salt of RIAA in ethanol was filtered through a 0.2 um syringe filter to remove the precipitated magnesium salt. The filtrate containing the RIAA in ethanol was then added drop wise with a Pasteur pipet to the beta-cyclodextrin suspension with constant stirring using a magnetic stirrer. The total time to add the entire amount of RIAA in ethanol was ten minutes.

The suspension was allowed to stand ˜30 minutes at 50-60 degrees C. with continued stirring using a magnetic stirrer. The suspension was allowed to cool to room temperature with constant stirring. Cooled suspension was then stored at 4 C for approximately 6 hours then filtered through a Whatman filter paper number 40 at room temperature.

The precipitated beta-cyclodextrins were allowed to air-dry at room temperature in a hood, then were washed with ˜5 mL of cold (˜4 C) ethanol to remove any excess RIAA. The resulting material was a light, powdered granular material.

### EXAMPLE 5

### Spectrophotometric Analysis of ρ-iso-α-Acids

This method provides quantification of ρ-iso-α-acids as free acid or as metal salts in blends, tablets, or raw material using a Beckman DU600. See “Spectrophotometric Analysis of ρ-iso-α-Acids”. Maye J P, Mulqueen S, Xu J, Weis, S. J. Am. Soc. Brew. Chem. 60(3): 98-100, 2002.

### 1.0 Materials, Equipment, Standards & Reagents

1.1 Materials
a. 100 mL volumetric or Erlenmeyer flasks
b. 1 mL and 100 mL glass volumetric pipettes
c. 0.2 μm, 13 mm, PTFE syringe filter
d. Quartz UV cuvettes

1.2 Equipment
a. Ultrasonicator
b. Luer-Lok tip syringe
c. Balance, 1 mg
d. 16 speed Osterizer blender with 8 oz. container or equivalent.
e. UV Spectrophotometer

1.3 Reagents & Solutions
a. 1.5 N NaOH in water
b. Alkaline 2-propanol (1% 1.5 N NaOH in 2-propanol), freshly prepared

### 2.0 Procedure

2.1 Sample Preparation—Tablet and Blends
a. Mix blend in blender at highest speed setting (frappe) for 2 minutes.
b. Grind the tablets then blend in the blender at highest speed setting (frappe) for 2 minutes.
c. Weigh sufficient material to get between 0.05 and 0.20 g of free acid into a 100 mL flask.
d. Record the weight of the sample.
e. Dissolve in 100 mL of freshly prepared alkaline 2-propanol (extraction volume).
f. Sonicate mixture for 20 minutes, remove and let stand a few minutes to allow larger particles to settle.
g. Filter through a 0.2 μm syringe filter disk.
h. Dilute 1.00 mL (aliquoted volume) of the filtered material to 100 mL (final volume) with freshly prepared alkaline 2-propanol using glass volumetric pipettes and/or a volumetric flask.
   Glassware used for diluting should be dry. If freshly cleaned glassware needs to be reused, rinse thoroughly with 2-propanol to remove any water or other solvent residue.

2.2 Sample Preparation—Raw Material

2.2.1 Dried Free Acid or Magnesium Salt
a. Blend raw material in the blender at the highest speed setting (frappe) for 2 minutes.
b. Weigh sufficient material to get between 0.05 and 0.20 g of free acid into a 100 mL flask. Record the weight of the sample.
c. Dissolve in 100 mL of alkaline 2-propanol (extraction volume).
d. Sonicate mixture for 20 minutes, remove and let stand a few minutes to allow larger particles to settle. If sonication does not completely dissolve material, place on a magnetic stirrer until all material has dissolved.
e. Filter through a 0.2 μm syringe filter disk.
f. Dilute 1.00 mL (aliquoted volume) of the filtered material to 100 mL (final volume) with alkaline 2-propanol using volumetric pipettes and/or a volumetric flask.
   Glassware used for diluting should be dry. If freshly cleaned glassware needs to be reused, rinse thoroughly to remove any water or other solvent residue.

2.2.2 Slurried Magnesium Salt
a. Pipette sufficient material to get between 0.05 g and 0.20 g of free acid into a 100-mL flask.
b. Depending on the amount of air in the slurry this will generally take between 0.5 and 1.0 mL. It may be necessary to cut the end off of a disposable pipette tip in order to transfer the slurry. Care should be taken not to deposit slurry material on the side of the flask, since this can dry out quickly and result in loss of sample.
c. Record the weight of the slurry sample.
d. Dissolve in 100 mL of alkaline 2-propanol (extraction volume).
e. Sonicate mixture for 20 minutes, remove and let stand a few minutes to allow larger particles to settle.
f. Filter through a 0.2 μm syringe filter disk.
g. Dilute 1.00 mL (aliquote volume) of the filtered material to 100 mL (final volume) with alkaline 2-propanol using glass volumetric pipettes and/or a volumetric flask.
   Glassware used for diluting should be dry. If freshly cleaned glassware needs to be reused, rinse thoroughly with 2-propanol to remove any water or other solvent residue.

2.3 Analysis
a. Use alkaline 2-propanol as a blank.
b. Take absorbance of sample at 253 nm using a Beckman DU 600 spectrophotometer.

### 3.0 Calculations

The total amount of reduced isoalpha acids (rho-isoalpha acids) assayed, in mg, can be calculated from the absorbance value at 253 nm.
   mg ρ iso α acids=Abs₂₅₃*185.2
   Where: Abs₂₅₃=absorbance of the sample at 253 nm.
   Appropriate adjustments can be made in the multiplier to account for different volumes and dilutions (ε=540 for a 1% solution of ρ iso α acids).
   mg ρ iso α acids in original extraction=(Abs₂₅₃/54)*Volₑₓₜ*(Vol_{f}/Volₐₗᵢ)

### Where:

Abs₂₅₃=absorbance of the sample at 253 nm
Volₑₓₜ=extraction volume, mL (100 mL)
Vol_{f}=final volume, mL (100 mL)
Volₐₗᵢ=aliquot volume, mL (1.00 mL)

In order to verify that the absorbance is due to the presence of rho-isoalpha acids, and not to some other matrix component, a chromatographic analysis of the sample should be done. This step is only needed in cases were there is some question about the actual identity of the material as rho-isoalpha acids.

This method tends to be quite sensitive to experimental technique. Care must be taken during all steps, particularly during the final dilution step. For the same reason, some degree of experience with the method is required in order to achieve acceptable results of +/−2% relative.

### EXAMPLE 6

### Sensory Evaluation Of A Powered Medical Food Drink Containing Beta-Cyclodextrin Encapsulated RIAA

Objective: To evaluate the perceived difference in intensity of bitterness in a powdered medical food containing Magnesium salt of RIAA vs Encapsulated RIAA.

Methodology: The participants were employees of Metagenics and could be categorized as “untrained” panelists.

Scoring was the sensory method used for evaluation to determine the difference in bitterness between samples.

Three samples of a rice based anti-inflammatory medical food A, B &C (U.S. Pat. No. 6,210,701 Medical Food for Treating Inflammation-Related Diseases (hereinafter “medical food”)) were given to the same set of panelists with a minimum of one hour intervals. The samples included the medical food A. without RIAA B. with the magnesium salt of RIAA and C. with encapsulated RIAA.

### Sample Preparation:

A: Rice based anti-inflammatory medical food, 52 gms per serving.
B: Rice based anti-inflammatory medical food with 200 mgs of RIAA, as the magnesium salt of RIAA (68% RIAA), per 52 gm serving.
C: Rice based anti-inflammatory medical food with 200 mgs of RIAA, as the encapsulated RIAA (7.6% RIAA), per 52 gm serving.

One serving of each of the samples listed above was mixed in a shaker cup with 8 oz of cold water. The samples were given to the panelist in a 1 oz plastic cup along with a response form. To avoid the influence among panelists conversations and discussions were not permitted during the testing.

The panelists were directed to evaluate the level of bitterness in each sample on the given scale:

______ Not bitter
______ Trace of bitterness

### ______ Slightly Bitter

### ______ Bitter

### ______ Very Bitter

### ______ Extremely Bitter

Panelists were asked to wait 5 minutes after tasting before responding.

### Data Analysis:

The ratings assigned by the judges were given numerical values, ranging from 0 points for “Not bitter” to 5 points for “Extremely bitter”. The results are shown in the following table.

N = 11

| | Medical | Samples | Medical Food with |
|---|---|---|---|
| | Food | Medical Food | Encap. RIAA |
| Panelist | Regular | with Mg. RIAA | 7.6% RIAA |
| 1 | 0 | 3 | 2 |
| 2 | 0 | 4 | 0 |
| 3 | 1 | 3 | 1 |
| 4 | 2 | 4 | 2 |
| 5 | 0 | 4 | 1 |
| 6 | 0 | 2 | 0 |
| 7 | 0 | 3 | 1 |
| 8 | 3 | 4 | 2 |
| 9 | 1 | 3 | 0 |
| 10 | 0 | 4 | 0 |
| 11 | 1 | 5 | 2 |
| Total | 8 | 39 | 11 |
| Average | 0.73 | 3.55 | 1 |

Interpretation: Based on the average, samples with the encapsulated RIAA (sample C) scored closer to the medical food without RIAA (Sample A). The sample with MgRIAA (sample B) scored 2.55 points higher on the 5 point bitterness score. It also should be noted that although samples with both Mg RIAA and encapsulated RIAA had 200 mg of RIAA per serving, the solubility of RIAA should be considered. It is likely that the entire amount of RIAA did not go into solution. Typically 50 ppm, the amount used in commercially available high bitter beers, is near the maximum solubility of RIAA in aqueous solution.

The data shows that for samples with Mg RIAA bitterness was perceived by 100% of the panelists. 36% of the panelists did NOT perceive bitterness in samples with encapsulated RIAA. Statistically, no significant difference was found between the regular medical food without RIAA and the medical food with encapsulated RIAA.

A one way ANOVA (Analysis Of Variance) showed a significant difference between samples with encapsulated RIAA and those with Mg RIAA. This indicates that encapsulation improves the masking of the bitter taste which is typical in products containing RIAA.

### JMP Oneway Analysis

Analysis of Variance

| Source | DF | Sum of Squares | Mean Square | F Ratio | Prob > F |
|---|---|---|---|---|---|
| product | 2 | 53.151515 | 26.5758 | 32.0073 | <.0001 |
| Error | 30 | 24.909091 | 0.8303 | | |
| C. Total | 32 | 78.060606 | | | |

Means and Std Deviations

| Level | Number | Mean | Std Dev | Std Err Mean | Lower 95% | Upper 95% |
|---|---|---|---|---|---|---|
| Medical Food Regular | 11 | 0.72727 | 1.00905 | 0.30424 | 0.0494 | 1.4052 |
| Medical Food with | 11 | 1 | 0.89443 | 0.26968 | 0.3991 | 1.6009 |
| Encap. RIAA | | | | | | |
| Medical Food with Mg. | 11 | 3.54545 | 0.8202 | 0.2473 | 2.9944 | 4.0965 |
| RIAA | | | | | | |

Means Comparisons
Dif = Mean[i] − Mean[j]

| | Medical Food | Medical Food | |
|---|---|---|---|
| | with Mg. | with Encap. | Medical |
| | RIAA | RIAA | Food Regular |
| Medical Food with | 0 | 2.5455 | 2.8182 |
| Mg. RIAA | | | |
| Medical Food with | −2.5455 | 0 | 0.2727 |
| Encap. RIAA | | | |
| Medical Food Regular | −2.8182 | −0.2727 | 0 |

Alpha = 0.05

### Comparisons for all Pairs Using Tukey-Kramer HSD

q*
2.46534
Abs(Dif)-LSD

| | Medical Food | Medical Food | |
|---|---|---|---|
| | with Mg. | with Encap. | Medical |
| | RIAA | RIAA | Food Regular |
| Medical Food with | −0.9579 | 1.5876 | 1.8603 |
| Mg. RIAA | | | |
| Medical Food with | 1.5876 | −0.9579 | −0.6852 |
| Encap. RIAA | | | |
| Medical Food Regular | 1.8603 | −0.6852 | −0.9579 |

Positive values show pairs of means that are significantly different.

Hops derivatives are particularly suitable for oral administration. Therefore, hops derivatives can be formulated for oral use, namely: tablets, coated tablets, dragees, capsules, powders, granulates and soluble tablets, and liquid forms, for example, suspensions, dispersions or solutions, optionally together with an additional active ingredient.

The selected dosage level will depend upon the activity of the particular composition, the route of administration, the severity of the condition being treated or prevented, and the condition and prior medical history of the patient being treated. However, it is within the skill of the art to start doses of the composition at levels lower than required to achieve the desired therapeutic effect and to gradually increase the dosage until the desired effect is achieved. If desired, the effective daily dose may be divided into multiple doses for purposes of administration, for example, two to four separate doses per day. It will be understood, however, that the specific dose level for any particular patient will depend upon a variety of factors including body weight, general health, diet, time and route of administration, combination with other compositions and the severity of the particular condition being treated or prevented.

As used herein, “pharmaceutically acceptable carrier” includes any and all solvents, dispersion media, coatings, isotonic and absorption delaying agents, sweeteners and the like. These pharmaceutically acceptable carriers may be prepared from a wide range of materials including, but not limited to, diluents, binders and adhesives, lubricants, disintegrants, coloring agents, bulking agents, flavoring agents, sweetening agents and miscellaneous materials such as buffers and absorbents that may be needed in order to prepare a particular therapeutic composition. The use of such media and agents for pharmaceutically active substances is well known in the art. Except insofar as any conventional media or agent is incompatible with the active ingredients, its use in the present composition is contemplated. In one embodiment, talc and magnesium stearate are included in the present formulation. Other ingredients known to affect the manufacture of this composition as a dietary bar or functional food can include flavorings, sugars, amino-sugars, proteins and/or modified starches, as well as fats and oils.

The dietary supplements, lotions or therapeutic compositions of the present invention can be formulated in any manner known by one of skill in the art. In one embodiment, the composition is formulated into a capsule or tablet using techniques available to one of skill in the art. In capsule or tablet form, the recommended daily dose for an adult human or animal would preferably be contained in one to six capsules of tablets. However, the present compositions may also be formulated in other convenient forms, such as an injectable solution or suspension, a spray solution or suspension, a lotion, gum, lozenge, food or snack item. Food, snack, gum or lozenge items can include any ingestible ingredient, including sweeteners, flavorings, oils, starches, proteins, fruits or fruit extracts, grains, animal fats or proteins. Thus, the present compositions can be formulated into cereals, snack items such as chips, bars, chewable candies or slowly dissolving lozenges.

The present invention contemplates treatment of all types of inflammation-based diseases, both acute and chronic. The present formulation reduces the inflammatory response and thereby promotes healing of, or prevents further damage to, the affected tissue. A pharmaceutically acceptable carrier may also be used in the present compositions and formulations.

According to the present invention, the animal may be a member selected from the group consisting of humans, non-human primates, such as dogs, cats, birds, horses, ruminants or other mammals and animals. The invention is directed primarily to the treatment of human beings.

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

1. An encapsulation composition, comprising:
a fraction isolated or derived from hops encapsulated in a compatible matrix but excluding a matrix which includes maltodextrins, modified starches, gum arabic, gelatin, hydrolyzed gelatin, and larch gum.

2. The encapsulation composition of claim 1, wherein the matrix is selected from at least one of the group consisting of a phytosterol and a cyclodextrin.

3. The encapsulation composition of claim 1, wherein the fraction isolated or derived from hops is selected from the group consisting of alpha acids, isoalpha acids, reduced isoalpha acids, tetra-hydroisoalpha acids, hexa-hydroisoalpha acids, beta acids, hop essential oils, and spent hops.

4. The encapsulation composition of claim 1, wherein the said fraction isolated or derived from hops comprises a compound of a supragenus having the formula: 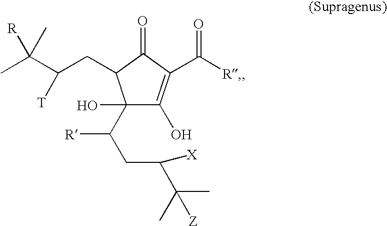
wherein R′ is selected from the group consisting of carbonyl, hydroxyl, OR, and OCOR,
wherein R is alkyl;
wherein R″ is selected from the group consisting of CH(CH₃)₂, CH₂CH(CH₃)₂, and CH(CH₃)CH₂CH₃;
and wherein R, T, X, and Z are independently selected from the group consisting of H, F, Cl, Br, I, and π orbital, with the proviso that if one of R, T, X, or Z is a π orbital, then the adjacent R, T, X, or Z is also a π orbital, thereby forming a double bond.

5. The encapsulation composition of claim 1, wherein said fraction isolated or derived from hops comprises a compound of Genus A having the formula: 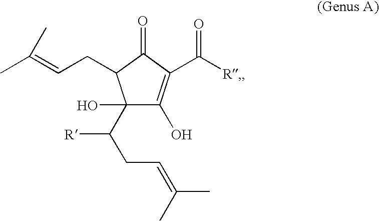
wherein R′ is selected from the group consisting of carbonyl, hydroxyl, OR, and OCOR, wherein R is alkyl;
and wherein R″ is selected from the group consisting of CH(CH₃)₂, CH₂CH(CH₃)₂, and CH(CH₃)CH₂CH₃.

6. The encapsulation composition of claim 1, wherein the fraction isolated or derived from hops comprises a compound of Genus B having the formula: 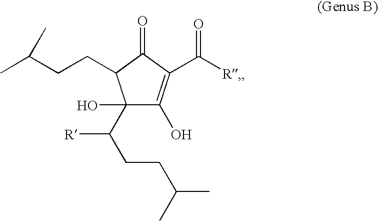
wherein R′ is selected from the group consisting of carbonyl, hydroxyl, OR, and OCOR, wherein R is alkyl;
and wherein R″ is selected from the group consisting of CH(CH₃)₂, CH₂CH(CH₃)₂, and CH(CH₃)CH₂CH₃.

7. The encapsulation composition of claim 1, wherein said fraction isolated or derived from hops comprises a compound selected from the group consisting of humulone, cohumulone, adhumulone, isohumulone, isocohumulone, isoadhumulone, dihydro-isohumulone, dihydro-isocohumulone, dihydro-adhumulone, tetrahydro-isohumulone, tetrahydro-isocohumulone, tetrahydro-adhumulone, hexahydro-isohumulone, hexahydro-isocohumulone, and hexahydro-adhumulone.

8. The encapsulation composition of claim 1, wherein the composition is capable of providing at least one of the following properties: (a) protecting from dissolution of the composition in an aqueous solution, (b) allowing dissolution of the composition in an acidic pH environment, (c) allowing dissolution of the composition in a mammalian stomach, (d) allowing dissolution of the composition in a mammalian large intestine, and (e) allowing dissolution of the composition in a mammalian small intestine.

9. The encapsulation composition of claim 8, wherein the composition is capable of substantially providing one of (a), (b), (c), (d), or (e) but substantially none of the other properties.

10. The encapsulation composition of claim 1, further comprising omega-3 fatty acids.

11. The encapsulation composition of claim 1, further comprising olive oil as a carrier for the fraction isolated or derived from hops.

12. The encapsulation composition of claim 1, wherein the composition is a powder.

13. A food product comprising the encapsulation composition of claim 1.

14. A food product comprising the encapsulation composition of claim 12.

15. A beverage product comprising the encapsulation composition of claim 1.

16. A beverage product comprising the encapsulation composition of claim 12.

17. A method of reducing or eliminating the bitter flavor imparted by a fraction isolated or derived from hops, comprising providing the encapsulation composition of claim 1.

18. A method of enhancing the stability of a fraction isolated or derived from hops, comprising providing the encapsulation composition of claim 1.

19. A method of providing timed or sustained release of a fraction isolated or derived from hops in a mammalian subject, comprising administering to the mammalian subject the encapsulation composition of claim 1.

20. A method of providing targeted delivery of a fraction isolated or derived from hops past the stomach of a mammalian subject, comprising administering to the mammalian subject the encapsulation composition of claim 1.

21. A method of increasing the bioavailability of a fraction isolated or derived from hops, comprising providing the encapsulation composition of claim 2 wherein the matrix is a cyclodextrin.

22. A method of making the encapsulation composition of claim 2, comprising:
heating the phytosterol to liquefaction;
adding and mixing the fraction isolated or derived from hops to the liquefied phytosterol; and
cooling the mixture to provide a hard composite.

23. A method of making the encapsulation composition of claim 12, comprising:
heating the phytosterol to liquefaction;
adding and mixing the fraction isolated or derived from hops to the liquefied phytosterol;
cooling the mixture to provide a hard composite; and
grinding the hard composite.

24. A method of making the encapsulation composition of claim 2, comprising:
suspending the cyclodextrin in an aqueous medium;
adding and mixing the fraction isolated or derived from hops to the suspension to form a hop fraction/cyclodextrin complex;
precipitating the hop fraction/cyclodextrin complex; and
drying the precipitate.

25. A method of making the encapsulation composition of claim 12, comprising:
suspending the cyclodextrin in an aqueous medium;
adding and mixing the fraction isolated or derived from hops to the suspension to form a hop fraction/cyclodextrin complex;
precipitating the hop fraction/cyclodextrin complex;
drying the precipitate; and
grinding the precipitate.
